(19) United States
(12) Patent Application Publication
(10) Pub. No.: US 2017/0059249 A1
(43) Pub. Date: Mar. 2, 2017

(54) HEAT TREATMENT JIG AND HEAT TREATMENT JIG ASSEMBLY APPARATUS

(71) Applicant: TAIYO WIRE CLOTH CO., LTD., Osaka, JP (US)

(72) Inventors: Junichi TATSUMI, Osaka (JP); Noriyoshi YAMAKITA, Osaka (JP); Shozo OOBA, Osaka (JP); Hiroshi YASUMOTO, Osaka (JP)

(21) Appl. No.: 15/103,041

(22) PCT Filed: Jul. 23, 2014
(86) PCT No.: PCT/JP2014/069425

§ 371 Date: Jun. 9, 2016

(30) Foreign Application Priority Data
Dec. 10, 2013 (JP) 2013-255484

(51) Int. Cl. F27D 3/12; F27D 5/00

(52) U.S. Cl. CPC F27D 3/12; F27D 5/0006; F27D 2003/121

(57) ABSTRACT

A jig frame and a wire mesh tray are reliably and simply fixed, and the wire mesh tray is simply replaced. A heat treatment jig includes a jig frame having on an upper surface side thereof an opening and a wire mesh tray having an upper end portion that abuts on an upper end portion of the jig frame. The wire mesh tray is detachably mounted on the jig frame by a plurality of clips. The clips grip the upper end portion of the jig frame and the upper end portion of the wire mesh tray.

### CROSS-REFERENCE TO RELATED APPLICATION

The present application is based on and claims priority from Japanese Patent Application No. 2013-255484, filed on Dec. 10, 2013, the disclosure of which is hereby incorporated by reference in its entirety.

### TECHNICAL FIELD

This invention is related to a heat treatment jig and a heat treatment jig assembly apparatus.

### BACKGROUND ART

Many small electric components are used in portable terminals such as cellular phones and tablet terminals. Such small electric components are often treated with heat at a high temperature.

When the small electric components are treated with heat, a heat treatment jig is used for placing all of the small electric components together in a heating furnace. The heat treatment jig includes a jig frame having on an upper surface side thereof an opening and a wire mesh tray having an upper end portion that abuts on an upper end portion of the jig frame. The jig frame and the wire mesh tray are integrally fixed.

Heat treatment targets such as small electric components are arranged on the wire mesh tray. The heat treatment jig houses inside thereof many heat treatment targets. Many heat treatment jigs in which many heat treatment targets are housed are placed in a batch type heating furnace with being stacked. Many heat treatment targets are thereby treated with heat at once.

The use of the wire mesh tray in the heat treatment jig improves heat transfer for rising heat treatment efficiency.

A heat treatment jig using a wire mesh tray is taught by Patent Literatures 1 and 2. In the heat treatment jig taught by Patent Literature 1, the wire mesh tray and the jig frame are fixed by another holding frame. In the heat treatment jig taught by Patent Literature 2, an end portion of the wire mesh tray is wound around the jig frame, and the overlapped portion of the end portion of the wire mesh tray is fixed by welding. It is also considered to sew the wire mesh tray into the jig frame.

### CITATION LIST

### Patent Literature

Patent Literature 1: JP H09-180972A

Patent Literature 2: JP2008-311386A

### SUMMARY

### Technical Problem

The heat treatment jig taught by Patent Literature 1, however, requires a large holding frame having approximately the same size as the jig frame, in addition to the jig frame and the wire mesh tray, and also has a problem in that a heat treatment target such as a small electric component may be caught or sandwiched between the holding frame and the wire mesh tray. If the heat treatment target is caught or sandwiched, the heat treatment target remaining on the heat treatment jig is deteriorated due to the repeated heat treatment. The deteriorated heat treatment target may drop off from the heat treatment jig, and be mixed with other preferable heat treatment targets.

The heat treatment jig taught by Patent Literature 2 also has a problem in that it takes a time to fix the overlapped portion of the wire mesh tray by the welding and it also takes a time to unfix the fixed portion. It is therefore difficult to replace the wire mesh tray. The wire mesh tray or the jig frame may be damaged by the heat of the welding.

Moreover, it is difficult to sew the wire mesh tray into the jig frame by passing a thin wire through the mesh of the wire mesh tray. Such sewing may lower the attachment force. For example, if the jig frame is suddenly lifted by holding only the edge of the wire mesh tray, the power is locally concentrated to the thin wire and the wire mesh tray. The thin wire may be cut or the wire mesh tray may break by such power. Furthermore, it takes a time to cut the thin wire when removing the wire mesh tray. These problems get worse as the size of the wire mesh of the wire mesh tray decreases.

### Solution to Problem

To solve the above problems, one embodiment of the present invention provides a heat treatment jig including a jig frame having on an upper surface side thereof an opening, and a wire mesh tray having an upper end portion that abuts on an upper end portion of the jig frame, wherein the wire mesh tray is detachably mounted on the jig frame by a plurality of clips, and the clips grip the upper end portion of the jig frame and the upper end portion of the wire mesh tray.

### Advantageous Effects

The upper end portion of the jig frame and the upper end portion of the wire mesh tray are reliably and simply gripped by a plurality of clips. The wire mesh tray can be simply replaced relative to the jig frame by unclipping the clips.

### BRIEF DESCRIPTION OF DRAWINGS

FIG. 1 is a perspective view illustrating an entire heat treatment jig according to an embodiment.

FIG. 2 is an exploded perspective view illustrating the heat treatment jig in FIG. 1.

FIG. 3 is an enlarged vertical cross-sectional view illustrating a part of the heat treatment jig to which a clip is attached.

FIG. 4A is a perspective view illustrating an entire clip formed of a wire.

FIG. 4B is a top view of FIG. 4A.

FIG. 4C is a side view of FIG. 4A.

FIG. 4D is a front view of FIG. 4A.

FIG. 4E is a perspective view illustrating an entire clip according to a modified example of FIG. 4A.

FIG. 4F is a top view of FIG. 4E.

FIG. 4G is a side view of FIG. 4E.

FIG. 4H is a front view of FIG. 4E.

FIG. 5 is a perspective view illustrating a clip formed of a metal plate.

FIG. 6 is an enlarged vertical cross-sectional view, similar to FIG. 3, illustrating a modified example of a jig holder.

FIG. 7A is an enlarged vertical cross-sectional view, similar to FIG. 3, illustrating a modified example of a jig holder and a clip receiver.

FIG. 7B is a side view of FIG. 7A illustrating the modified example of the jig holder and the clip receiver.

FIG. 8 is a view illustrating another modified example of a jig holder and a clip receiver.

FIG. 9 is a perspective view illustrating an entire heat treatment jig assembly apparatus.

FIG. 10 is a partially enlarged side view of FIG. 9.

FIG. 11 is a partially enlarged perspective view of FIG. 10.

### DESCRIPTION OF EMBODIMENT

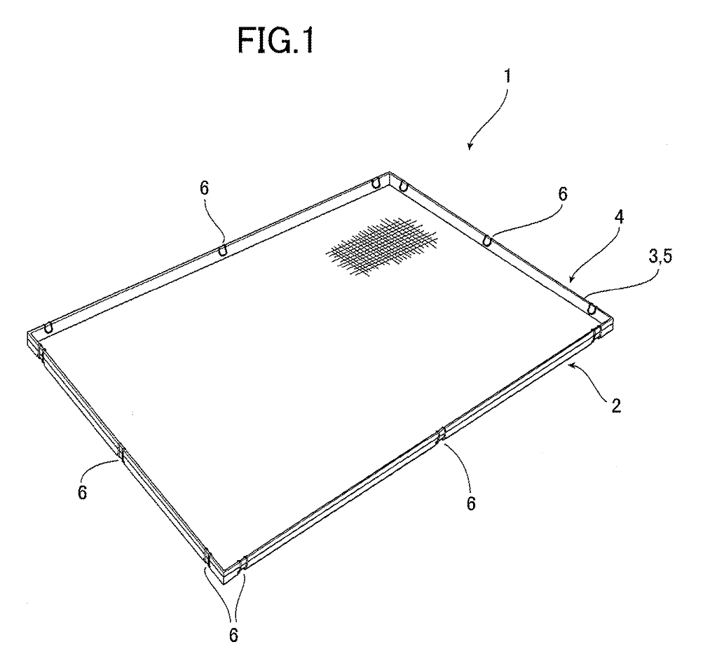

Hereinafter an embodiment of the present invention will be described with reference to the drawings. FIGS. 1 to 11 are views for describing the present embodiment.

The configurations will be described below.

A heat treatment jig 1 illustrated in FIG. 1 is used for treating a small heat treatment target with heat in a heating furnace.

Note that the heat treatment target may be any target as long as it is a small component that requires heat treatment. The small component intends to a small component that is not suitable for placing alone in a heating furnace for heat treatment. The heat treatment target intends to a small electric component for use in a portable terminal such as a cellular phone and a tablet type terminal. The heat treatment target intends to a small machine component such as a sintered ring for use as a bearing of a mechanical device. In addition, the heat treatment target is not limited to the above. Such small electric components and machine components are increasingly downsized and light-weighted so as to downsize and reduce the thickness and the weight of the portable terminals and the mechanical devices.

The heating furnace is a device for heat treatment. A batch type heating furnace, which performs the heat treatment one by one, or a serial type heating furnace, which continuously performs the heat treatment, is used as the heating furnace. The heating furnace for use in the heat treatment of small electric components or machine components has an ability of the heat treatment at about 800° C. to 1300° C. or more.

The heat treatment jig 1 includes a jig frame 2 having on an upper surface side thereof an opening and a wire mesh tray 4 having an upper end portion 5 that abuts on an upper end portion 3 of the jig frame 2. The wire mesh tray 4 is detachably mounted on the jig frame 2 by a plurality of clips 6. In this case, the clips 6 grip both of the upper end portion 3 of the jig frame 2 and the upper end portion 5 of the wire mesh tray 4.

Here, the heat treatment jig 1 is a shallow edged container such as a tray in which many small heat treatment targets are arranged. It is preferable for the heat treatment jig 1 to be stacked. This heat treatment jig 1 is absolutely necessary for effective treating many small heat treatment targets with heat to be mass-produced. More specifically, the heat treatment jig 1 is a very important jig for a manufacturing process of an electric component or a machine component. Note that the heat treatment jig 1 has an approximate rectangular shape in a planer view.

The jig frame 2 is a frame constituting a basic form of the heat treatment jig 1. The jig frame 2 is made of a refractory metal such as nickel base alloy (for example, Inconel 601(Inconel: Registered Trademark No. 298860)), so as to have a heat treatment tolerance.

The wire mesh tray 4 is set up on the jig frame 2 to effectively heat the small heat treatment targets placed on the wire mesh tray 4. The wire mesh tray 4 is made of a sophisticated material having a tolerance for heat treatment repeated in the heating furnace.

This wire mesh tray 4 is made by spraying ceramic particles such as zirconia on the surface of the wire mesh main body made of refractory metal such as nickel.

The fineness of the mesh of the wire mesh tray 4 depends on the size of the heat treatment target to be housed. It is necessary to reduce the mesh size and the thickness of the wire mesh tray 4, and also to soften the wire mesh tray 4 in accordance with downsizing in the heat treatment target. The force of the wire mesh tray 4 therefore decreases and the wire mesh tray 4 becomes breakable in accordance with an improvement in the quality of the heat treatment target. Accordingly, it becomes increasingly difficult for the wire mesh tray 4 to be fixed to the jig frame 2. For example, it is difficult to sew the wire mesh tray 4 into the jig frame 2 with a fine needle, and the attachment force of the wire mesh tray 4 to the jig frame 2 by sewing may be insufficient. As the power is easily and locally concentrated to the fine needle and the wire mesh tray 4, the fine needle and the wire mesh tray 4 are easily broken. Such a problem gets worse in accordance with a decrease in the mesh size of the wire mesh tray 4. The present wire mesh tray 4 is a plain weave having a mesh of 0.25 φ×40, for example. It is difficult for such a wire mesh tray 4 to be fixed by sewing.

The clip 6 is a simple clip that clips an object and an object by using an elastic force. This clip 6 has a fixing force which does not unclip while in use. By using such a clip 6, the wire mesh tray 4 can be simply clipped regardless of the fineness of the mesh of the wire mesh tray 4. As the size (diameter and thickness) of the clip 6 is not limited by the fineness of the mesh of the wire mesh tray 4, the clip 6 can be easily designed. Even if the heat treatment jig 1 is suddenly lifted by holding only the edge of the wire mesh tray 4 where the clip 6 is not provided, and the excessive force acts on the wire mesh tray 4, such power is distributed to the clip 6 significantly larger than the mesh of the wire mesh tray 4 or unclips the clip 6. The wire mesh tray 4 is therefore prevented from being broken.

The clip 6 is a heat-resistant clip that hardly deforms by heat. The heat-resistant performance required for the clip 6 differs depending on the temperature of the heat treatment for the heat treatment target. In this case, the clip 6 is treated with heat at about 800° C. to 1300° C. or more. The clip 6 is therefore made of a material such as nickel base alloy, which hardly deforms at a high temperature and does not lose a spring property. When the heat-resistant clip is made of nickel base alloy, the heat-resistant clip having a significant tolerance for the use in an extremely harsh situation such as repeated heat treatment at a high temperate in the heating furnace is obtained.

The nickel base alloy is alloy in which iron, chrome, niobium, and molybdenum are blended with nickel as a base. The nickel base alloy is a sophisticated material having extremely good heat resistance and abrasion resistance. Various types of nickel base alloy can be used depending on the blending ratio of iron, chrome, niobium, and molybdenum. In this case, the clip 6 has a property that hardly deforms by heat expansion and heat, and does not lose an elastic force required as the clip 6 even though the heat treatment is repeated. In one example, Inconel 601 or Inconel 718 is used for the clip 6.

The wire mesh tray 4 and the jig frame 2 are fixed in arbitrary positions by a plurality of clips 6. Each side of the rectangular jig frame 2 is clipped by at last one clip 6.

In this case, each side of the jig frame 2 is clipped by the three clips 6 provided in both end portions and the central portion, in order to reliably fix the wire mesh tray 4 to the jig frame 2 and simplify the handling of the heat treatment jig 1. By providing the three clips 6 in each side, the wire mesh tray 4 does not separate from the jig frame 2 regardless of the holding posture of the heat treatment jig 1. The wire mesh tray 4 can be thus reliably fixed to the jig frame 2. The power acting on the wire mesh tray 4 can be well distributed to a plurality of clips 6, and the wire mesh tray 4 can be stably fixed to the jig frame 2 without being damaged.

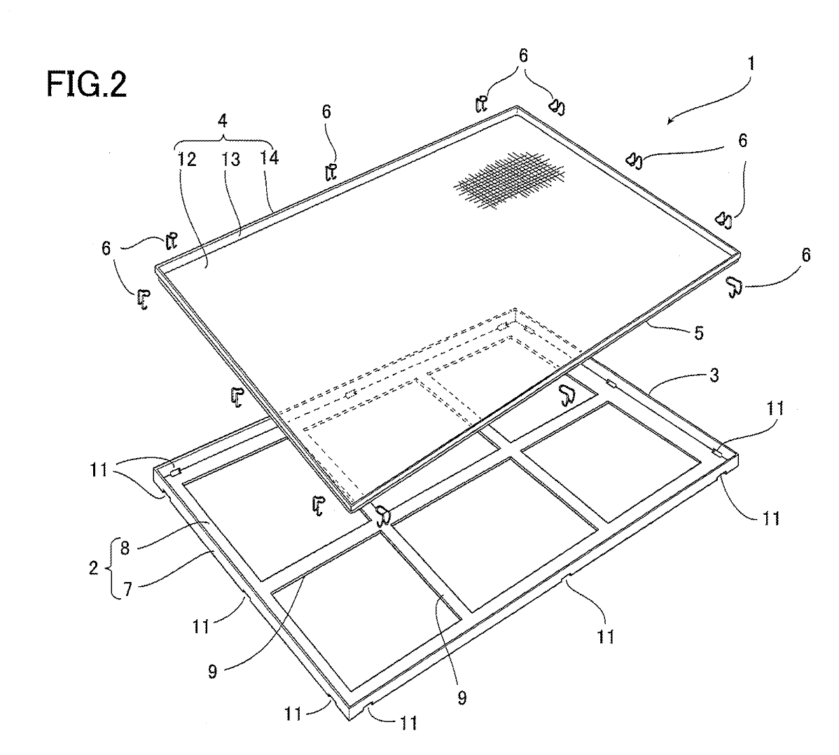

Next, the details of the heat treatment jig 1 will be described with reference to the exploded perspective view of FIG. 2.

The jig frame 2 includes a side frame portion 7 and a lower end portion 8 that bends inward from the lower portion of the side frame portion 7. The side frame portion 7 and the lower end portion 8 are integrated.

The side frame portion 7 is a rectangular vertical frame, in a planer view, rising from the lower end portion 8. The side frame portion 7 may vertically rise from the lower end portion 8 or may rise oblique outward. The jig frame 2 has the upper end portion 3 as an upper end portion of the side frame portion 7.

The lower end portion 8 is a rectangular horizontal frame in a planer view. The wire mesh tray 4 is set up on the top surface of the lower end portion 8. An opening is formed inside the lower end portion 8. The opening includes according to needs a rail 9 that prevents the wire mesh tray 4 from protruding downward from the opening due to the flexibility of the wire mesh tray 4. The rail 9 may be a vertical rail or a horizontal rail across the opening, which is integrated to the lower end portion 8 of the jig frame 2.

A plurality of clip receivers 11 is formed in the lower end portion of the jig frame 2 in accordance with the positions of the clips 6.

The wire mesh tray 4 includes at least a wire mesh main body 12 disposed to cover the entire top surface of the lower end portion 8 of the jig frame 2 and a rising portion 13 provided to rise from the end portion of the wire mesh main body 12 in the inside of the side frame portion 7 of the jig frame 2. The rising portion 13 may vertically rise from the wire mesh main body 12 or may rise oblique outward from the wire mesh main body 12. When the rising portion 13 inclines, the heat treatment target is hardly caught by the rising portion 13. The rising portion 13 has approximately the same height as the upper end portion 3 of the jig frame 2. The rising portion 13 is disposed inside the jig frame 2 to be adjacent to the jig frame 2. Note that the upper end portion 5 of the wire mesh tray 4 is the upper end portion of the rising portion 13.

A turned edge portion 14 that covers at least the upper portion of the outside surface of the side frame portion 7 through the upper end portion 3 of the jig frame 2 can be provided in the upper end portion 5 of the rising portion 13. By providing the turned edge portion 14, the entire circumference of the wire mesh tray 4 is stably held by the jig frame 2. The size of the portion of the wire mesh tray 4 that can be fastened by a fastening portion 22 of the clip 6 can be increased, and the wire mesh tray 4 can be thereby further stably fixed to the jig frame 2. The wire mesh main body 12 and the rising portion 13 or the wire mesh main body 12, the rising portion 13, and the turned edge portion 14 are integrated to be formed into a shallow edged container.

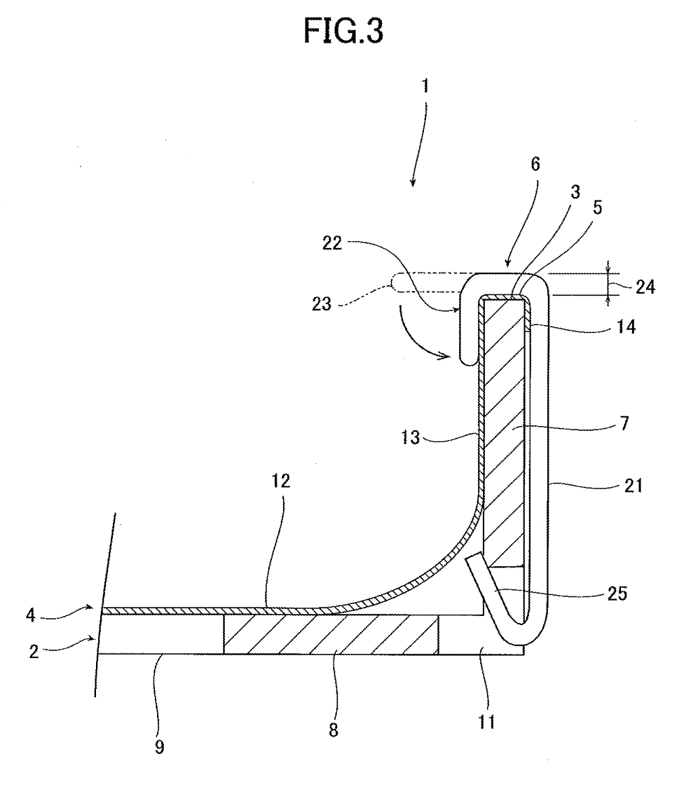

Next, the clip 6 will be described with reference to the partially enlarged vertical cross-sectional view of the heat treatment jig 1 in FIG. 3. In FIG. 3, the boundary between the wire mesh main body 12 and the rising portion 13 has an R shape having a large curvature. The heat treatment target is thereby hardly caught by the boundary.

The clip 6 includes a clip main body 21 and a portion that extends inside the jig frame 2 from the clip main body 21 beyond the upper end portion 3 of the jig frame 2. The fastening portion 22 is formed by bending the portion downward. The fastening portion 22 of the clip 6 grips the upper end portion 3 of the jig frame 2 and the upper end portion 5 of the wire mesh tray 4. The wire mesh tray 4 can be removed from the jig frame 2 by bending the fastening portion 22 of the clip 6 upward.

The clip main body 21 has a length that is approximately the same as the height of the jig frame 2, and extends in the up and down direction. The clip main body 21 is disposed to substantially abut on the outside surface of the jig frame 2.

The portion that extends inside the jig frame 2 from the clip main body 21 beyond the upper end portion 3 of the jig frame 2 is a temporal holder 23 that temporarily holds the upper end portion 3 of the jig frame 2 in which the wire mesh tray 4 is placed. In this case, the temporal holder 23 is a hook that is bent at equal to 90° or less relative to the clip main body 21. The temporal holder 23 has a length that is approximately longer than the thickness of the jig frame 2, so as to ensure a required fastening margin.

The fastening portion 22 is formed by bending the temporal holder 23 downward to have an approximate downward C shape.

The fastening portion 22 of the clip 6 is used as a mesh protector 24 capable of protecting the wire mesh tray 4 from another jig frame 2 placed on the upper side. The wire mesh tray 4 is often damaged due to the friction when the heat treatment jig 1 is stacked. The mesh protector 24 therefore protects the wire mesh tray 4 from the friction in the stacking.

The mesh protector 24 is also used as a spacer configured by the shape of the clip 6 (fastening portion 22) that covers the upper end portion 3 of the jig frame 2 and the thickness of the clip 6 (diameter of needle or thickness of plate spring). The thickness of the spacer is set such that the wire mesh tray 4 separates from the jig frame 2 of another heat treatment jig 1 provided above to avoid the friction.

More specifically, in order to maintain both of the holding performance of the clip 6 relative to the wire mesh tray 4 and the detachability of the clip 6 relative to the heat treatment jig 1 (in this case, deformation of fastening member 22), the diameter or the thickness of the clip 6 is set to 0.1 mm to 2.0 mm, for example. However, it is necessary to set the diameter or the thickness of the clip 6 to be about 0.5 mm to 0.8 mm, in order to use the clip 6 as the spacer. 0.1 mm is the lower limit diameter or thickness that obtains the required holding performance. 2.0 mm is the upper limit diameter or thickness that easily detaches the clip 6. 0.5 mm is the lower limit diameter or thickness that obtains the function as the spacer required for protecting the wire mesh tray 4. 0.8 mm is the most suitable diameter or thickness that obtains the function as the spacer required for protecting the wire mesh tray 4.

A jig holder 25 is formed in the clip main body 21. The clip 6 holds the jig frame 2 by the jig holder 25. The clip 6 engages with the jig frame 2 to hold the jig frame by the jig holder 25, so as to prevent the downward C shape fastening portion 22 from being unclipped upward. Before fastening the fastening portion 22, the jig holder 25 is detachable relative to the jig frame 2. After fastening the fastening portion 22, the jig holder 25 is fixed, so that the jig frame 2 is held by the fastening portion 22 and the jig holder 25. After fastening the fastening portion 22, the jig holder 25 cannot be detached unless the clip 6 is deformed.

A plurality of clip receivers 11 is provided in the jig frame 2. The clip receiver 11 is formed of a cutout provided in the lower end portion of the jig frame 2. The clip receiver 11 is a receiver by which the jig holder 25 of the clip 6 easily and reliably holds the jig frame 2.

More specifically, the jig holder 25 is a lower locking portion that is provided in the lower end portion of the clip main body 21, and is locked to the lower portion of the jig frame 2. The clip receiver 11 is a cutout that is provided in the lower portion of the jig frame 2, and into which the lower locking portion is inserted from the lower side to be locked.

The lower locking portion is formed substantially below the fastening portion 22. The lower locking portion is formed by bending the lower end portion of the clip main body 21 inward and upward to have a J shape having a sharp angle, for example. The lower locking portion is inserted into the clip receiver 11 (cutout) of the jig frame 2 from the lower side to the upper side to be locked for preventing the upward movement. In this case, the lower locking portion is bent relative to the clip main body 21 to have a folded shape having an interval that is approximately the same as the thickness of the side frame portion 7 of the jig frame 2. The lower end portion is thus tightly locked in the cutout.

The cutout is formed in the corner between the lower end portion 8 and the side frame portion 7 across the lower end portion 8 and the side frame portion 7. The cutout is formed in a position corresponding to the position of the clip 6 of the jig frame 2. The cutout may be formed only in the outer circumference end portion of the lower end portion 8 of the jig frame 2. The cutout may be formed only in the lower end portion of the side frame portion 7 of the jig frame 2.

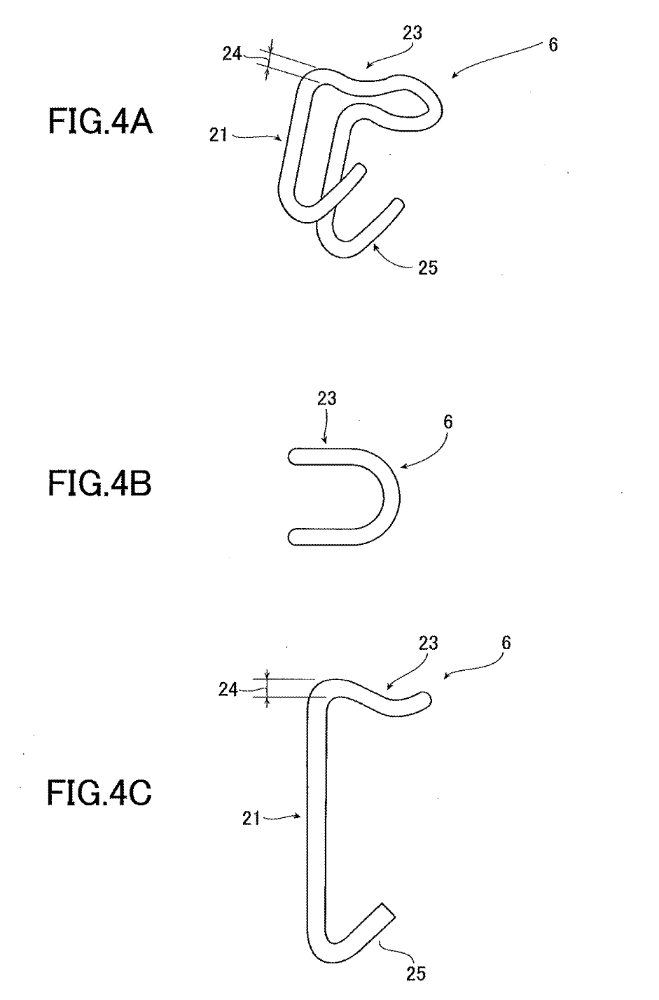

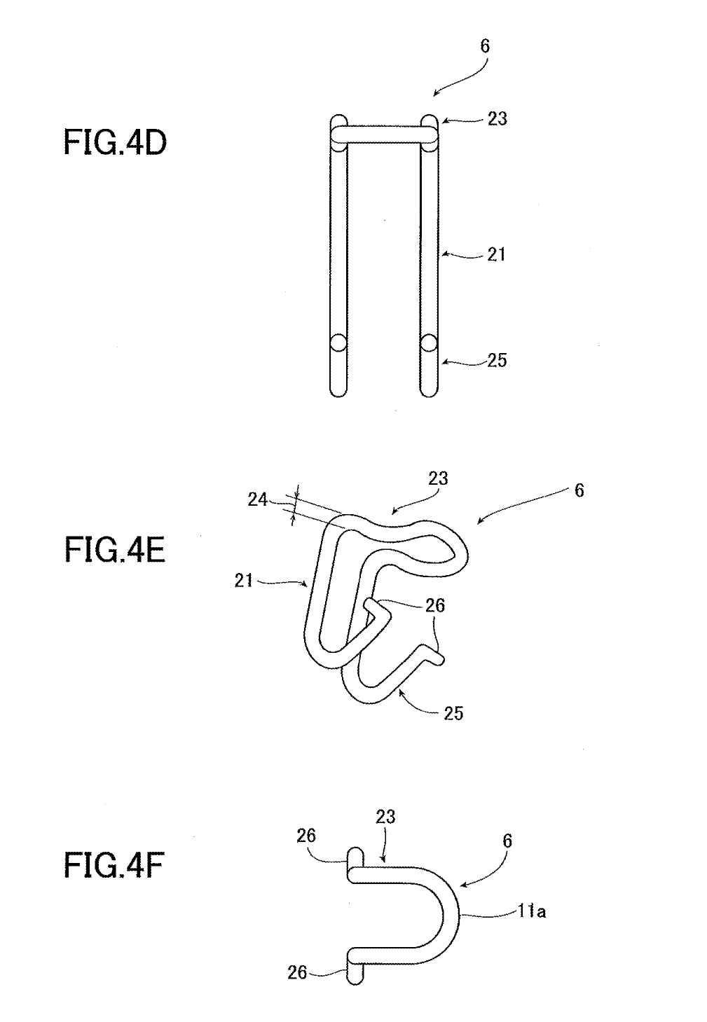

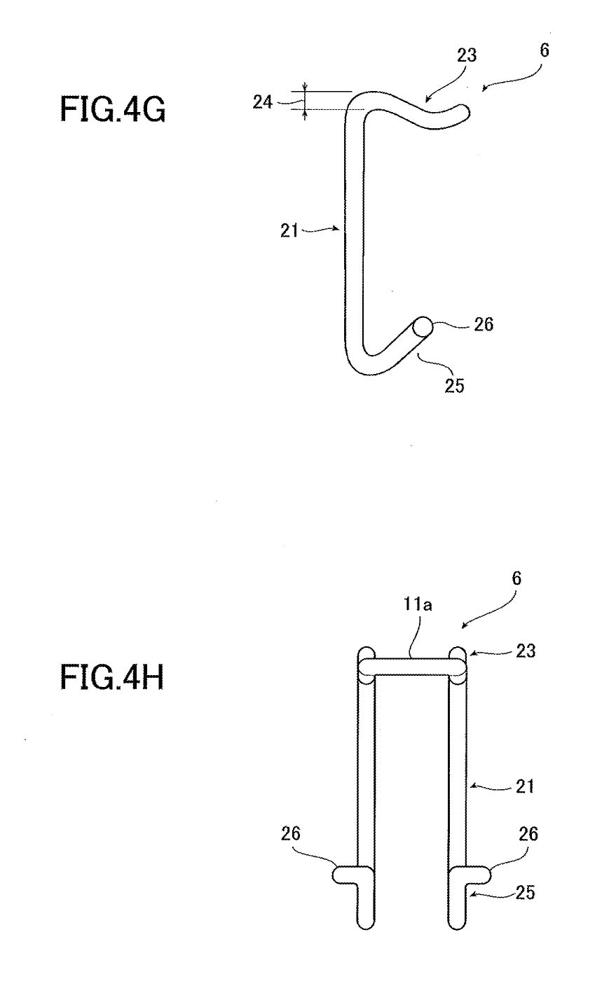

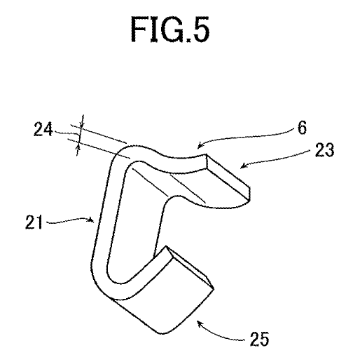

FIGS. 4A to 4D illustrate one example of the clip 6 formed of one wire. The clip 6 includes a pair of clip shaped portions each having the temporal holder 23 and the jig holder 25 in the upper end and lower end portions of the clip main body 21, respectively. A pair of clip shaped portions is integrally connected by the end portions of the temporal holders 23. In this case, an intermediate portion between the temporal holders 23 is a curved portion that has a U shape or a V shape in a side view and partially curves downward (jig holder 25 side). When the temporal holder 23 has a downward bypass shape, an upward inclined portion formed in the leading end portion of the temporal holder 23 is used as an attachment guide having a guide shape. The clip 6 is thereby easily attached to the jig frame 2 and the wire mesh tray 4 to temporarily hold the jig frame 2 and the wire mesh tray 4. The clip 6 is also deformed into a tight shape after fastening.

FIGS. 4E to 4H illustrate a modified example of FIG. 4A. In this modified example, an extended portion 26 that extends outside in the width direction is provided in the end portion of the jig holder 25 of the clip 6. The extended portion 26 extends outside to be larger than the width of the clip receiver 11 (cutout). The jig holder 25 is therefore hardly removed from the clip receiver 11 (cutout).

FIG. 5 illustrates one example in which the clip 6 is formed of a metal plate. The clip 6 having a function similar to that in FIG. 4A, which is formed of the wire, is obtained even though the metal plate is used.

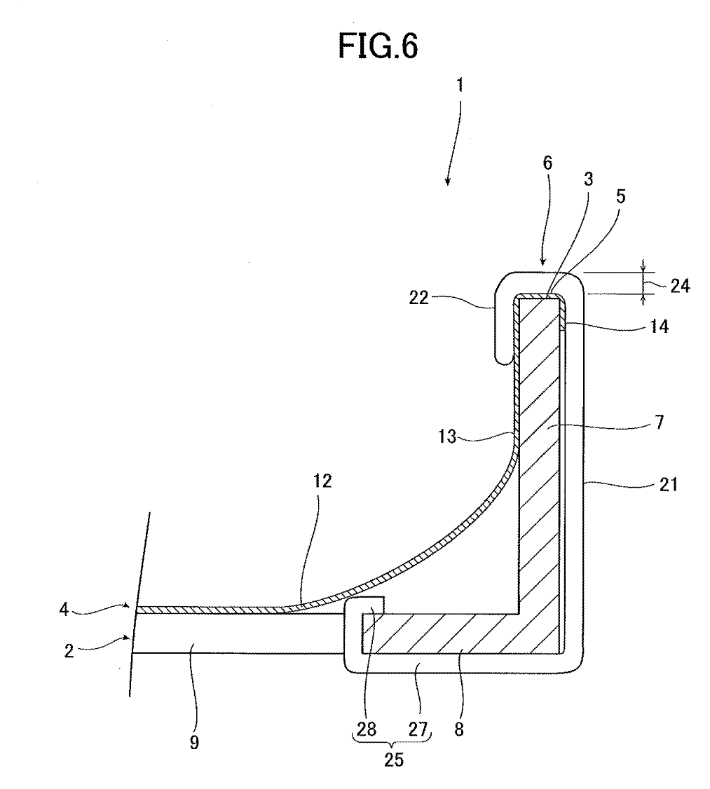

The jig holder 25 will be hereinafter described. As is not specifically illustrated by the figure, the jig holder 25 includes a bent portion capable of being directly locked to the lower surface of the jig frame 2. As illustrated in FIG. 6, the jig holder 25 includes a traverse portion 27 that extends inside the jig frame 2 through the underneath of the lower end portion 8 of the jig frame 2 and a bent portion 28 that is locked to an end portion of an opening in the lower end portion 8 from the lower side. In this case, the jig holder 25 is locked in the position shifted inside the jig frame 2 by the traverse portion 27 without being locked just below the fastening portion 22.

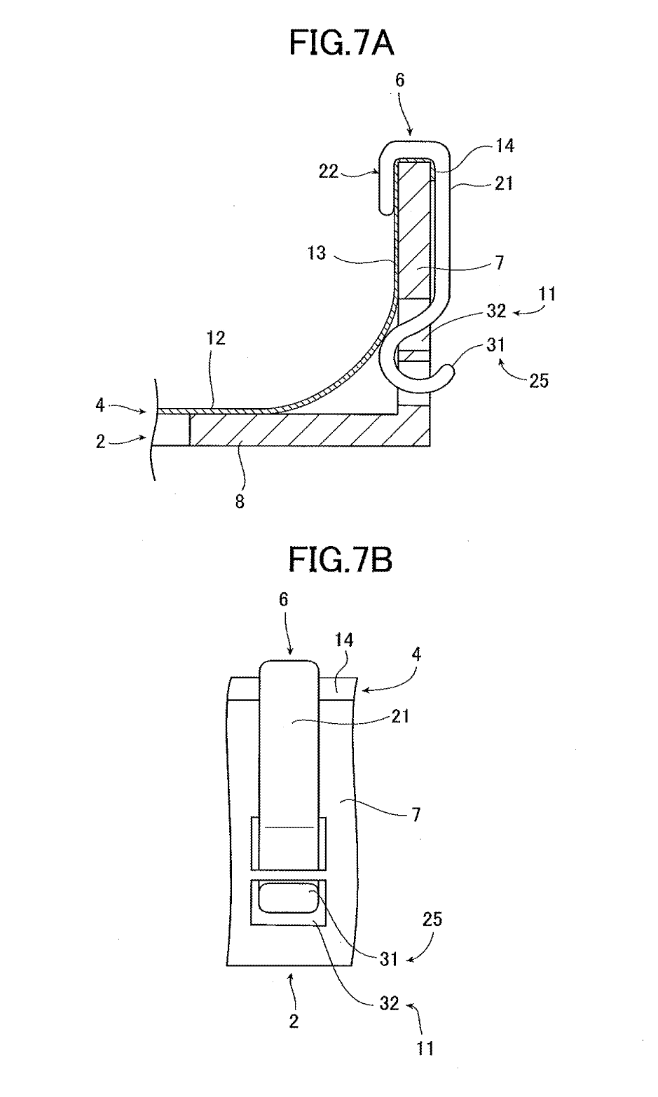

As illustrated in FIGS. 7A and 7B, the jig holder 25 may be an arc-like hook 31 that is provided in the lower end portion of the clip main body 21, and is capable of being locked to the intermediate portion or the lower half portion of the side frame portion 7 of the jig frame 2 by being inserted thereinto in the lateral direction to rotate. The clip receiver 11 is a locking hole 32 provided in the intermediate portion or the lower portion of the side frame portion 7 of the jig frame 2. The locking hole 32 has an approximate θ shape in a side view having a middle bar as a rotation center or a locking portion after the insertion of the hook 31.

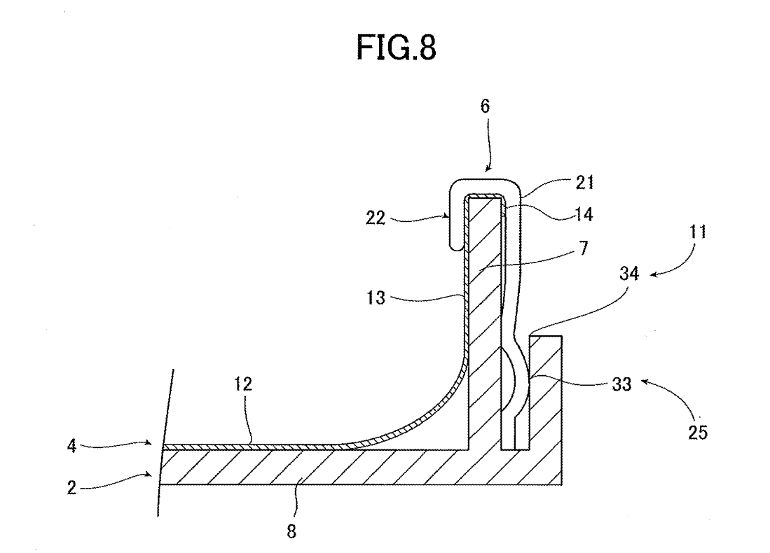

As another modified example illustrated in FIG. 8, the jig holder 25 may be an elastic contact piece 33 having a side bypass shape that is provided in the lower end portion of the clip main body 21. The clip receiver 11 may be an upward concave portion 34 or an upward groove for housing the elastic contact piece. The upward concave portion 34 or the upward groove is provided in the external surface of the intermediate portion or the lower portion of the side frame portion 7 of the jig frame 2. The concave portion 34 or the groove is formed to have a space narrower than the lateral bypass amount of the elastic contact piece 33. The elastic contact piece 33 can be thereby elastically held by being pressed into the concave portion 34 from the upper side to the lower side. In addition, although the concave portion 34 is formed in a part of the jig frame 2, the groove is formed in the entire circumference of the jig frame 2.

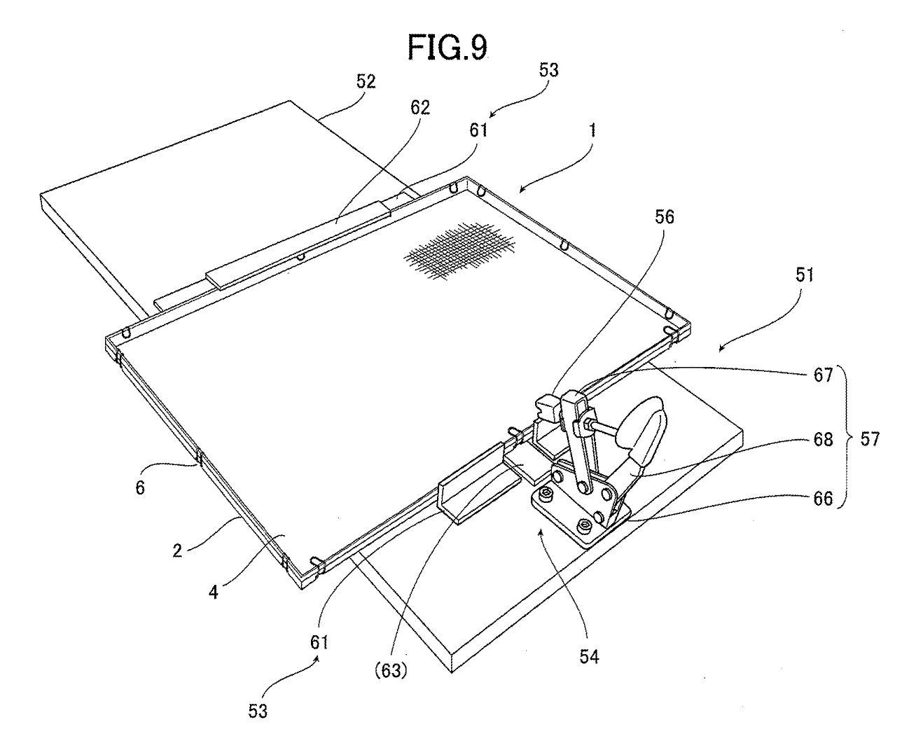

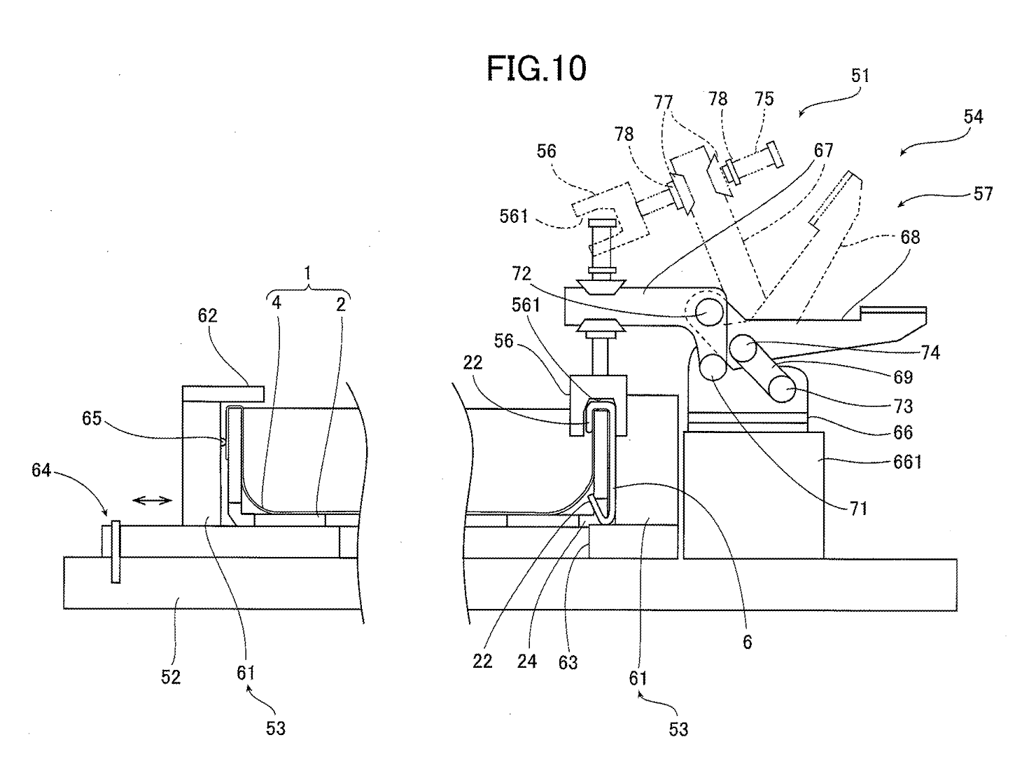

A heat treatment jig assembly apparatus 51 for assembling the heat treatment jig 1 will be described with reference to FIGS. 9 and 10.

The heat treatment jig assembly apparatus 51 includes a frame holder 53 that holds the jig frame 2 on which the wire mesh tray 4 is set up and a clip fastener 54 that fastens the upper end portion 3 of the jig frame 2 and the upper end portion 5 of the wire mesh tray 4 to be held by deforming the clip 6.

The heat treatment jig assembly apparatus 51 includes a flat base plate 52. The base plate 52 is made up of a plate body such as a metal plate having an area required for stably placing the jig frame 2. It is preferable for the base plate 52 to have a size in which the maximum jig frame 2 can be paced in accordance with various sizes and shapes of the jig frame 2, so as to improve the versatility of the heat treatment jig assembly apparatus 51.

The frame holder 53 can be any holder as long as it can hold the jig frame 2.

The clip fastener 54 may be any mechanism as long as it can fasten the clip 6. The clip fastener 54 includes a head portion 56 that presses the clip 6 from the upper side and a head elevator 57 that elevates the head portion 56 to fasten the clip 6 or unfasten the clip 6. The clip fastener 54 is integrally attached to the base plate 52.

The frame holder 53 includes at least a pair of frame holding members 61 capable of holding at least a pair of opposed sides of the jig frame 2. One frame holding member 61 includes a frame stopper 62 capable of preventing the jig frame 2 from being uplifted in the fastening. The other frame holding member 61 includes a position regulator 63 capable of positioning the jig frame 2 in the fastening position of the clip 6 by the clip fastener 54.

The frame holding members 61 are a pair of parallel pressing members (stoppers) fixed on the top surface of the base plate 52. The frame holding member 61 has a height that is substantially the same as the jig frame 2 (side frame portion 7) or is higher than that.

It is preferable for the one frame holding member 61 to be movable to be close to or away from the other frame holding member 61 and to be positioned and fixed relative to the other frame holding member 61 in parallel with the other frame holding member 61 in accordance with the various sizes of the frame holding member 61. In this case, the one frame holding member 61 is attached to the base plate 52 through a slider 64 (refer to FIG. 10).

A jig frame pressing mechanism 65 (refer to FIG. 10) that presses the side surface of the jig frame 2 toward the other frame holding member 61 to stably hold the jig frame 2 may be provided in the inside surface of the frame holding member 61 if necessary. The jig frame pressing mechanism 65 generates a pressing force by an elastic body such as a plate spring or a coil spring attached to the inside surface of the frame holding member 61.

The frame stopper 62 is locked to the upper end portion 3 of the jig frame 2 (side frame portion 7) from the upper side. The frame stopper 62 is an upper locking portion having an eaves shape that extends from the upper portion of the one frame holding member 61 toward the other frame holding member 61. The height of the frame stopper 62 can be adjusted according to the various jig frames 2 each having a different height.

The position regulator 63 is a protrusion piece that protrudes form the position of the other frame holding member 61 and extends toward the one frame holding member 61. The protrusion piece may be an insertion piece that is inserted into the clip receiver 11 (hole). It is preferable for the position regulator 63 to be inserted into the clip receiver 11 (hole) in the position of the fastening by the clip fastener 54 for improving the positional accuracy.

Hereinafter, the detailed configuration of the clip fastener 54 will be described. The following description will be given based on the fastening as a standard.

The head portion 56 has a block shape. The head portion 56 includes in a bottom surface thereof a fastening groove 561 (refer to FIG. 10) having a shape required for tightly fastening the fastening portion 22 of the clip 6 with the small extended amount inside the jig frame 2 and good reproducibility of the griping shape. The head elevator 57 is a link mechanism including a base 66 for attaching the clip fastening mechanism 54 to the base plate 52, an elevation arm 67 for elevating the head portion 56, and an operation lever 68 for a lever operation, as shown in FIG. 10. In this case, an auxiliary link member 69 that adjusts the operation of the link mechanism is provided between the operation lever 68 and the base 66.

The base 66 is fixed to the base plate 52 with a bolt in the up and down direction. The base 66 is directly fixed to the base plate 52 or is indirectly fixed to the base plate 52 via a spacer 661.

The elevation arm 67 has an approximate L shape in a side view. The leading end portion of the elevation arm 67 is located above the other frame holding member 61. The head portion 56 is attached to the lower portion of the elevation arm 67. The back end portion of the elevation arm 67 is supported by a shaft 71 in the base 66 near the frame holding member 61 to rotate up and down.

The operation lever 68 has an approximate V shape in a side view. The leading end portion of the operation lever 68 is supported by the intermediate portion of the elevation arm 67 to rotate up and down about a shaft 72. The back end portion of the operation lever 68 is an operation end having a grip.

The lower end portion of the auxiliary link member 69 is supported by the base 66 to rotate back and forth about a shaft 73. The upper end portion of the auxiliary link member 69 is supported by the intermediate portion of the operation lever 68 to rotate up and down about a shaft 74. In addition, each of the shafts 71, 72, 73, and 74 extends in the longitudinal direction of the other frame holding member 61.

When the back end portion of the operation lever 68 is pushed down to rotate downward about the shaft 74, the leading end portion of the elevation arm 67 rotates downward about the shaft 71, and the head portion 56 moves downward for fastening. On the other hand, when the back end portion of the operation lever 68 is pushed up to rotate upward about the shaft 74, the leading end portion of the elevation arm 67 rotates upward about the shaft 71, and the head portion 56 moves upward for releasing the fastening to be back to the initial position. A return spring that biases the back end portion of the operation lever 68 upward may be provided in the link mechanism.

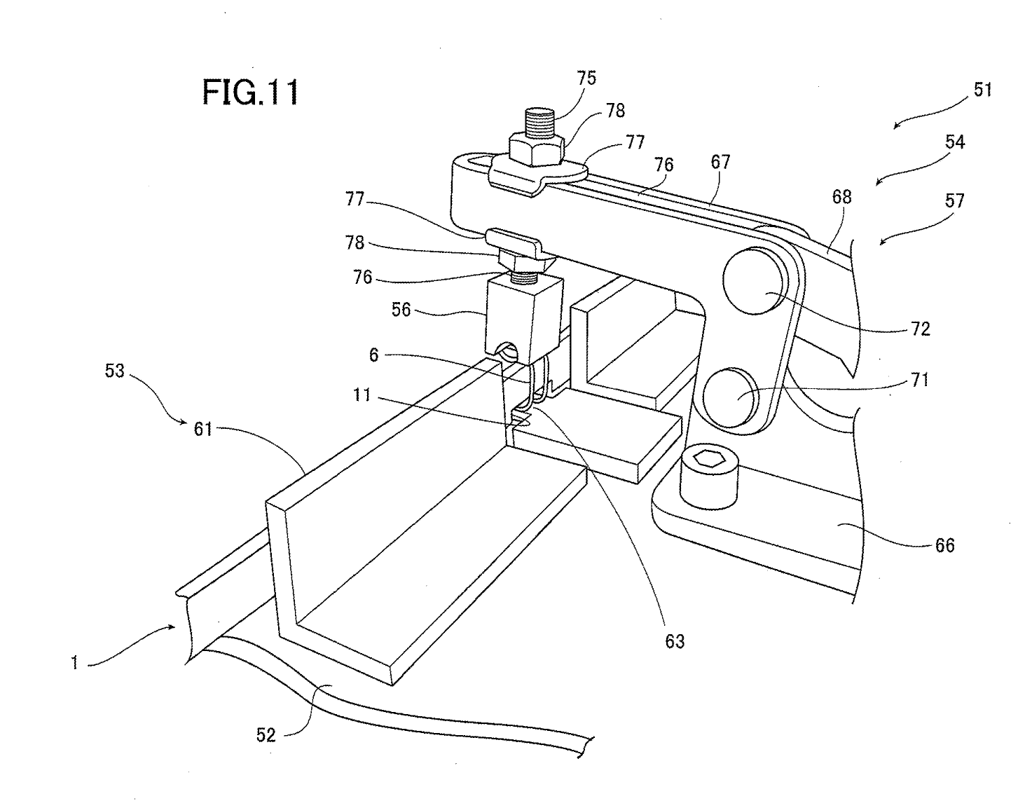

As illustrated in FIG. 11, a position adjustor may be provided between the elevation arm 67 and the head portion 56 according to the various shapes of the heat treatment jig 1 and the clip 6. This position adjustor includes a height adjustor and an anteroposterior position adjustor, for example.

The height adjustor is a screw mechanism, for example. The screw mechanism includes a screw shaft 75, a shaft insertion portion 76, a pair of plate members 77 for controlling a position, and a pair of nuts 78 for adjusting a position. The screw shaft 75 is attached to the top surface of the head portion 56 to extend upward. The shaft insertion portion 76 is formed in the leading end portion of the elevation arm 67 (lateral arm portion) to penetrate therethrough in the up and down direction. A pair of plate members 77 is disposed to sandwich, in the up and down direction, the leading end portion of the elevation arm 67, and has a shaft hole facing the shaft insertion portion 76. A pair of nuts 78 is screwed to the screw shaft 75 that is inserted through the holes of the plate members 77 and the shaft insertion portion 76 of the elevation arm 67 to sandwich the plate members 77 in the up and down direction. The height is adjusted by changing the screwing position of the nuts 78 relative to the screw shaft 75.

The anteroposterior position adjustor is a slider, for example. The slider is configured by forming the shaft insertion portion 76 of the elevation arm 67 into a long hole or a slit that extends in the extending direction of the elevation arm 67 (lateral arm portion) and the plate member 77 into a slide plate capable of sliding along the elevation arm 67 (extending direction of lateral arm portion). The anteroposterior position is adjusted by sliding the plate member 77 as the slide plate relative to the slit shaft insertion portion 76 to change the position relative to the longitudinal direction of the shaft insertion portion 76 to be fixed.

The head portion 56 can be exchanged with respect to the elevation arm 67 based on the structure of the position adjustor. A plurality of head portions 56 each having a different shape of the fastening groove 561 is prepared, and the head portion is exchanged according to a situation. The head portion 56 therefore widely corresponds to the jig or the clip 6 of various sizes.

According to the present embodiment, the following functions can be obtained.

The heat treatment jig 1 houses many heat treatment targets by arranging the heat treatment targets on the wire mesh tray 4. Many heat treatment jigs 1 in which many heat treatment targets are housed are stacked, and inserted in the batch type heating furnace. The many heat treatment targets are thereby treated with heat at one time. When the heat treatment is performed in the continuous type heating furnace, the heat treatment targets are provided in the heating furnace through a conveyer. In this case, the heat treatment jigs 1 are stacked or not stacked.

Such a heat treatment jig 1 is assembled as follows. The wire mesh tray 4 is integrally fixed to the jig frame 2 by the clips 6. The heat treatment jig 1 can be precisely and uniformly assembled by fastening the clips 6 with the heat treatment jig assembly apparatus 51.

More specifically, the wire mesh tray 4 is placed inside the jig frame 2, and the jig frame 2 and the wire mesh tray 4 are temporarily held by the clips 6.

The specific procedure of the temporal holding by the clips 6 is as follows. Namely, the jig holder 25 of the clip 6 is inserted into the clip receiver 11 (cutout) of the jig frame 2 to be locked. Then, the clip main body 21 rotates toward the jig frame 2 about the contact portion between the jig holder 25 and the clip receiver 11. The clip main body 21 thereby abuts on the outside surface of the jig frame 2, and the fastening portion 22 exceeds the upper end portion 3 of the jig frame 2, and the temporal holder 23 engages with the upper end portion 3 of the jig frame 2 for the temporal holding.

Next, the jig frame 2 to which the wire mesh tray 4 is temporarily clipped by the clips 6 is placed on the base plate 52 of the heat treatment jig assembly apparatus 51, and these are held by the frame holder 53 of the heat treatment jig assembly apparatus 51. The clips 6 are fastened by the clip fastener 54 of the heat treatment jig assembly apparatus 51. In this case, the clip fastener 54 presses the fastening portion 22 of the clip 6 from the upper side to be deformed. The upper end portion 3 of the jig frame 2 and the upper end portion 5 of the wire mesh tray 4 are gripped to be fastened. The jig frame 2 and the wire mesh tray 4 are integrated by performing such an operation to all of the clips 6.

At least a pair of frame holding members 61 is provided in the frame holder 53 of the heat treatment jig assembly apparatus 51. At least a pair of opposed sides of the jig frame 2 is reliably and effectively held by a pair of frame holding members 61 with a simple configuration.

The one frame holding member 61 is provided with the frame stopper 62. The jig frame 2 is thereby prevented from being uplifted in the fastening. By preventing the uplift of the side of the jig frame 2 on the side away from the clip fastener 54, the side of the jig frame 2 on the side close to the clip fastener 54 is hardly uplifted. The jig frame 2 can be therefore appropriately held.

The other frame holding member 61 is provided with the position regulator 63. The jig frame 2 is therefore reliably fixed in the fastening position of the clip 6 by the clip fastener 54.

A pair of frame holding members 61 is provided with the frame stopper 62 and the position regulator 63, respectively. The configuration of the heat treatment jig assembly apparatus 51 is thereby streamlined and the fastening operation by the clip fastener 54 is stably and simply performed. The heat treatment jig 1 is therefore easily and appropriately assembled.

According to this embodiment, the following effects can be obtained.

The heat treatment jig 1 includes the jig frame 2 having on the upper side thereof the opening and the wire mesh tray 4 having the upper end portion 5 that abuts on the upper end portion 3 of the jig frame 2. The wire mesh tray 4 is detachably mounted on the jig frame 2 by a plurality of clips 6. In this case, the clips 6 grip the upper end portion 3 of the jig frame 2 and the upper end portion 5 of the wire mesh tray 4. The jig frame 2 and the wire mesh tray 4 are thereby simply and reliably fixed. In addition, the clip 6 is freely and manually attached by using a tool such as a nipper or is tightly attached by using the heat treatment jig assembly apparatus 51. It is especially advantageous to use the heat treatment jig assembly apparatus 51 for shorting the operation time and obtaining good reproducibility in a simple manner as described below.

By removing the clips 6 from the heat treatment jig 1 with a tool such as a nipper, the jig frame 2 and the wire mesh tray 4 are simply separated, and the wire mesh tray 4 is easily replaced. By replacing the wire mesh tray 4, when the wire mesh tray 4 is damaged, the jig frame 2 is repeatedly used. Accordingly, the costs required for the heat treatment jig 1 is controlled.

Another holding frame or a welder is not required for fixing the wire mesh tray 4. The mounting and dismounting of the wire mesh tray 4 can be simplified without additional component costs or welding, and the wire mesh tray 4 is attached or replaced without heat influence due to the welding or the deformation of the jig frame due to the holding frame. The no use of the holding frame prevents the heat treatment target from being sandwiched or caught by the heat treatment jig 1.

In addition, the use of the clip 6 to the jig (heat treatment jig 1) that is repeatedly treated with heat at a high temperature is not usual as the fixing force of the clip weakens by the deformation of the clip 6 caused by the heat or the lack of the elastic force and the clip 6 is insensitively removed. However, in this embodiment, the heat-resistant clip 6 is used. The clip 6 is therefore a highly reliable fastener which hardly deforms even though it is repeatedly treated with heat at a high temperature, and does not lose the elastic force required for fixing.

As a result, the jig frame 2 and the wire mesh tray 4 can be fixed by the clip 6. The heat-resistant clip uses a material according to a temperature of a heat treatment. For example, when the heat treatment temperature is low, the clip 6 made of iron or stainless is used. As the present embodiment, when the heat treatment is performed at a high temperature, the clip 6 made of nickel group alloy is used as the heat-resistant clip.

The jig frame 2 includes the side frame portion 7 and the lower end portion 8 that integrally extends from the lower portion of the side frame portion 7 to bend inward. The opening is formed in the lower end portion 8. The heat is therefore effectively transferred through the jig frame 2, and the jig frames 2 are therefore easily stacked. The opening includes the rail 9. The rail 9 supports a part of the wire mesh tray 4 in the opening. The wire mesh tray 4 is thereby reliably prevented from protruding downward from the opening due to the flexibility of the wire mesh tray 4 by the deformation caused by the repeated heat treatment. Thus, the wire mesh tray 4 is not significantly deformed, and the load or the stress to the clip 6 caused by the deformation of the wire mesh tray 4 are prevented. The clip 6 and the wire mesh tray 4 are reliably protected from the load or the stress caused by the deformation of the wire mesh tray 4. When the rail 9 includes a vertical rail and a horizontal rail across the opening, the wire mesh tray 4 is partially supported, and the opening is divided into a plurality of small holes. The wire mesh tray 4 thereby hardly protrudes downward, and thus, the above effects are reliably obtained.

The clips 6 grip the upper end portion 3 of the jig frame 2 and the upper end portion 5 of the wire mesh tray 4 by the fastening portions 22. The fastening portion 22 is formed by bending downward the portion of the clip 6 that extends inside of the jig frame 2 from the clip main body 21 beyond the upper end portion 3 of the jig frame 2. The jig frame 2 and the wire mesh tray 4 are simply and reliably fixed by using the clips 6 without providing a hole in the wire mesh tray 4. The wire mesh tray 4 is fixed in a simple manner, and the wire mesh tray 4 is prevented from being damaged.

The fastening portion 22 of the clip 6 is used as the mesh protector 24. The wire mesh tray 4 located on the lower side is thereby effectively protected from abutting on the jig frame 2 of another heat treatment jig 1 placed on the upper side. When the heat treatment jigs I are stacked, the wear of the wire mesh tray 4 of the lower heat treatment jig 1 due to the jig frame 2 of the upper heat treatment jig 1 is controlled. The operating life of the wire mesh tray 4 is therefore extended, and the frequency of replacing the wire mesh tray 4 is reduced. In this case, as illustrated in FIGS. 4A and 4E, when the clip 6 is made of a wire, the mesh protector 24 becomes indistinctive. As illustrated in FIG. 5, when the clip 6 is made of a metal plate, the mesh protector 24 is formed into a planer shape, and such a clip 6 clips the wire mesh tray 4 with a wider plane.

The fastening portion 22 of the clip 6 is provided with the temporal holder 23. The clip 6 thereby temporarily holds (self-holding) the upper end portion 3 of the jig frame 2 when performing the fastening operation of the jig frame 2 and the wire mesh tray 4 with the clips 6. Thus, the fastening operation is significantly simplified. After all of the clips 6 temporarily hold the upper end portion 3 of the jig frame 2, a process is divided to continuously perform the fastening operation. Accordingly, the productivity is improved.

A plurality of clip receivers 11 is provided in the lower end portion of the jig frame 2. The clip receiver 11 is formed by cutting off the lower end portion of the jig frame 2. The clip 6 thereby simply and reliably holds the jig frame 2, and the gripping of the jig frame 2 and the wire mesh tray 4 by the clip 6 is not released. In this case, the clip 6 is provided with the jig holder 25. The jig holder 25 is inserted into the clip receiver 11 of the jig frame 2 from the lower side to be held to the clip receiver 11. The fastening operation is performed by the fastening portion 22. The fastening by both of the jig holder 25 and the fastening portion 22 has reliability and stability higher than the fastening only by the fastening portion 22.

The heat treatment jig assembly apparatus 51 includes the frame holder 53 and the clip fastener 54. The frame holder 53 holds the jig frame 2 in which the wire mesh tray 4 is placed, and the clip fastener 54 presses the clip 6 to be bent, so that the upper end portion 3 of the jig frame 2 and the upper end portion 5 of the wire mesh tray 4 are gripped to be fixed. By using such a heat treatment jig assembly apparatus 51, the wire mesh tray 4 is attached to the jig frame 2 with a simple operation, and the high quality heat treatment jig 1 is appropriately assembled. Moreover, by using such a heat treatment jig assembly apparatus 51, the clip 6 is fastened without an unnecessary load to the jig frame 2. The clips 6 are tightly and appropriately fastened by the fastening groove 561 provided in the head portion 56 in a short time with the small extended amount inside the jig frame 2 and good reproducibility of the gripping shape. On the other hand, if the clips are manually bent by using a tool such as a nipper, the extended amount of the fastened clip 6 inside the jig frame 2 may be increased, and the clips may not be tightly and appropriately fastened in a short time.

### REFERENCE SIGNS LIST

1 Heat treatment jig

2 Jig frame

3 Upper end portion

4 Wire mesh tray

5 Upper end portion

6 Clip

11 Clip receiver

21 Clip main body

22 Fastening portion

23 Temporal holder (portion that extends inside jig frame beyond upper end portion of jig frame)

1. A heat treatment jig comprising:
a jig frame including on an upper surface side thereof an opening; and
a wire mesh tray including an upper end portion that abuts on an upper end portion of the jig frame, wherein
the wire mesh tray is detachably mounted on the jig frame by a plurality of clips, and
the clips grip the upper end portion of the jig frame and the upper end portion of the wire mesh tray.

2. The heat treatment jig according to claim 1, wherein
the clip includes a fastening portion formed by bending downward a portion of the clip that extends inside the jig frame from a clip main body beyond the upper end portion of the jig frame, and
the fastening portion grips the upper end portion of the jig frame and the upper end portion of the wire mesh tray.

3. The heat treatment jig according to claim 1, wherein
a plurality of clip receivers is formed in the jig frame by cutting off a lower end portion of the jig frame.

4. A heat treatment jig assembly apparatus that assembles the heat treatment jig according to claim 1, the apparatus comprising:
a frame holder that holds the jig frame in which the wire mesh tray is placed; and
a clip fastener that fixes the clips to grip the upper end portion of the jig frame and the upper end portion of the wire mesh tray by pressing the clips to be bent.
